(19) United States
(12) Patent Application Publication
(10) Pub. No.: US 2026/0320189 A1
(43) Pub. Date: Oct. 15, 2026

(54) MACHINE-LEARNING BASED METHOD FOR PERFORMING AI SECURITY ANALYSIS BASED ON A COMPARISON OF PREDICTED COMPUTATIONAL PARAMETERS

(71) Applicants: Constructor Technology AG, Schaffhausen (CH); Constructor Education and Research Genossenschaft, Schaffhausen (CH)

(72) Inventors: Alexander Tormasov, Bremen (DE); Ivan Tsyganov, Neuchatel (CH); Kevin Reed, Singapore (SG); Laurent Dedenis, Geneve (CH); Stanislav Protasov, Singapore (SG); Serg Bell, Singapore (SG); Nikolay Dobrovolskiy, Alanya (TR)

(21) Appl. No.: 19/176,662

(22) Filed: Apr. 11, 2025

(51) Int. Cl. G06F 21/57; G06F 8/77

(52) U.S. Cl. CPC G06F 21/57; G06F 8/77

(57) ABSTRACT

Disclosed herein are systems and methods for analyzing safety of software code associated with scientific or technical documents before execution of the software code. The method includes: receiving a scientific or technical document and software code associated with the scientific or technical document; analyzing the software code using a first prepared machine learning model (MLM) to predict a first computational parameters (e.g., model) based on the software code, wherein the first computational parameters indicates computational resources and/or data sources utilized for execution of the software code; analyzing the scientific or technical document using a second prepared MLM to predict a second computational parameters based on the scientific or technical document and a known computational parameters of a similar scientific or technical document; comparing the first and second computational parameters to generate a similarity score; and determining whether it is safe to execute the software code based on the similarity score

### FIELD OF TECHNOLOGY

The present disclosure relates to the field of machine learning, and, more specifically, to systems and methods for machine-learning based methods for performing artificial intelligence (AI) security analysis by comparing predicted computational parameters from code analysis and predicted computational parameters from article analysis.

### BACKGROUND

Hackers can introduce viruses and backdoor vulnerabilities into software code by manipulating computational parameters (e.g., computational models) during the development and benchmarking phases. If a hacker inserts malicious code disguised as a computational model, it may bypass detection by appearing to align with expected parameters. As an example, a piece of malware could be embedded within dead code branches or hidden in an algorithm that mimics legitimate computations. By exploiting weaknesses in code validation processes, hackers can introduce vulnerabilities that enable remote access, data theft, or system corruption, making it crucial to refine benchmarking and similarity checks to detect and prevent such security threats. In this way, discrepancies between predicted and actual resource utilization could indicate unauthorized operations, such as hidden data exfiltration or unauthorized network access. As an example, if an article describes calculation of solar flares, but the software code associated with that article actually collects passwords, then the software code should be flagged as malicious or suspicious.

### SUMMARY

To perform security analysis on complex computational models attached to scientific or technical documents, the present disclosure describes preparing machine learning models (MLMs) to predict a first computational model based on software code and analyzing a scientific document using a second MLM to predict a second computational model based on the scientific document and a known computational model of a similar scientific document. Specifically, the present disclosure describes determining whether it is safe to execute the software code based on a comparison of the first and second computational model. Accordingly, if the first and second computational models are similar then the MLMs determine that the codes are similar in characteristic and, thus, may be considered is safe to execute.

In one exemplary aspect, a method for analyzing safety of software code associated with scientific or technical documents before execution of the software code is disclosed. The method includes: receiving a scientific or technical document and software code associated with the scientific or technical document, wherein the software code includes executable code and/or source code; analyzing the software code using a first prepared machine learning model (MLM) to predict a first computational model based on the software code, wherein the first computational model indicates computational resources and/or data sources utilized for execution of the software code; analyzing the scientific or technical document using a second prepared MLM to predict a second computational model based on the scientific or technical document and a known computational model of a similar scientific or technical document, wherein the second computational model indicates computational resources and/or data sources utilized for potential execution of the software code for performing calculations in the scientific or technical document; comparing the first and second computational models to generate a similarity score; and determining whether it is safe to execute the software code based on the similarity score.

In some aspects, the techniques described herein relate to a method, wherein analyzing the scientific or technical document using a second prepared MLM comprises: using the second prepared MLM to identify, in a database of previously analyzed scientific or technical documents and associated software codes, at least one scientific or technical document substantially similar to the received scientific or technical document; for the identified similar document, retrieving from the database, the known computational model based on the software code associated with the similar document; and using the second prepared MLM to predict the second computational model based on the known computational model and differences between the received document and similar document.

In some aspects, the techniques described herein relate to a method, wherein determining whether it is safe to execute the software code based on the similarity score further comprises: when the similarity score is above a first threshold, determining that it is safe to execute the software code and generating a recommendation to execute the software code to a user; when the similarity score is below a second threshold, determining that it is unsafe to execute the software code and generating a recommendation to not execute the software code to the user; when the similarity score is between the first and second thresholds, generating a recommendation review the software code to the user.

In some aspects, the techniques described herein relate to a method further including: extracting live portions of code from the software code associated with the scientific or technical document and analyzing the extracted live portions of code using the first prepared MLM, wherein the live portion corresponds to segment of code that is actively executing, updating, or responding in real-time within a system.

In some aspects, the techniques described herein relate to a method, wherein using the second prepared MLM to predict the second computation model based on the known computational model and differences between the received document and the similar document further comprises: determining a document similarity benchmark based on comparison of the received document and the similar document using the second prepared MLM, wherein the similarity benchmark indicates degree of similarity of the compared documents; and modifying one or more computational resources of the known computational model based on the similarity benchmark to predict corresponding computational resource for the second computational model.

In some aspects, the techniques described herein relate to a method, wherein computational resources comprise one or more of: processor utilization, memory utilization, number of computational iterations, or duration of the computation, and/or network utilization.

In some aspects, the techniques described herein relate to a method further including: preparing the first MLM by: (1) providing, to the first MLM, a code analysis training dataset comprising at least: (a) a code training dataset comprising at least source code and metadata corresponding to features for the source code to extract patterns that predict computational parameters, (b) a computational parameter training dataset comprising at least data requirement information and execution configuration information to provide ground truth labels for computational parameters required for execution, (c) a code-document interaction training dataset comprising at least annotations, mapping rules, and execution example logs to provide additional context about how the software code was executed, and (d) ground truth labels for the code training dataset, the computational parameter training dataset, and the code-document interaction training dataset to serve as a target output for the first MLM; and (e) ground truth labels for the code training documents dataset, the computational parameter training dataset, and the code-document interaction dataset to serve as a target output for the first MLM; and (2) preparing the first MLM using the code analysis training dataset.

In some aspects, the techniques described herein relate to a method further including: further comprising: preparing the second MLM by: (1) providing, to the second MLM, a document analysis training dataset comprising at least: (a) a training documents dataset comprising at least text of training documents and metadata to enable similarity analysis and prediction, wherein the training documents dataset is labeled and annotated to identify a subject matter to group documents, (b) a code training dataset comprising at least source code associated with the training documents and metadata corresponding to features of source code to capture features from code associated with the training documents to provide execution context, (c) a computational parameter training dataset comprising at least execution settings and execution logs to provide ground truth labels for computational parameters required for execution, (d) a similarity training dataset comprising at least document similarity pairs, code similarity pairs, and cross-mapping data to establish relationships between documents based on similarity and associated execution parameters,(e) ground truth labels for the training documents dataset, the code training dataset, the computational parameter training dataset, and the similarity training dataset to serve as a target output for the second MLM; and (2) preparing the second MLM using the document analysis training dataset.

According to one aspect of the disclosure, a system is provided for analyzing safety of software code associated with scientific or technical documents before execution of the software code, the system including: at least one memory; and at least one hardware processor coupled with the at least one memory and configured, individually or in combination, to: receive a scientific or technical document and software code associated with the scientific or technical document, wherein the software code includes executable code and/or source code; analyze the software code using a first prepared machine learning model (MLM) to predict a first computational model based on the software code, wherein the first computational model indicates computational resources and/or data sources utilized for execution of the software code; analyze the scientific or technical document using a second prepared MLM to predict a second computational model based on the scientific or technical document and a known computational model of a similar scientific or technical document, wherein the second computational model indicates computational resources and/or data sources utilized for potential execution of the software code for performing calculations in the scientific or technical document; compare the first and second computational models to generate a similarity score; and determine whether it is safe to execute the software code based on the similarity score.

In one exemplary aspect, a non-transitory computer-readable medium is provided storing a set of instructions thereon for analyzing safety of software code associated with scientific or technical documents before execution of the software code, the system, including instructions for: receiving a scientific or technical document and software code associated with the scientific or technical document, wherein the software code includes executable code and/or source code; analyzing the software code using a first prepared machine learning model (MLM) to predict a first computational model based on the software code, wherein the first computational model indicates computational resources and/or data sources utilized for execution of the software code; analyzing the scientific or technical document using a second prepared MLM to predict a second computational model based on the scientific or technical document and a known computational model of a similar scientific or technical document, wherein the second computational model indicates computational resources and/or data sources utilized for potential execution of the software code for performing calculations in the scientific or technical document; comparing the first and second computational models to generate a similarity score; and determining whether it is safe to execute the software code based on the similarity score.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

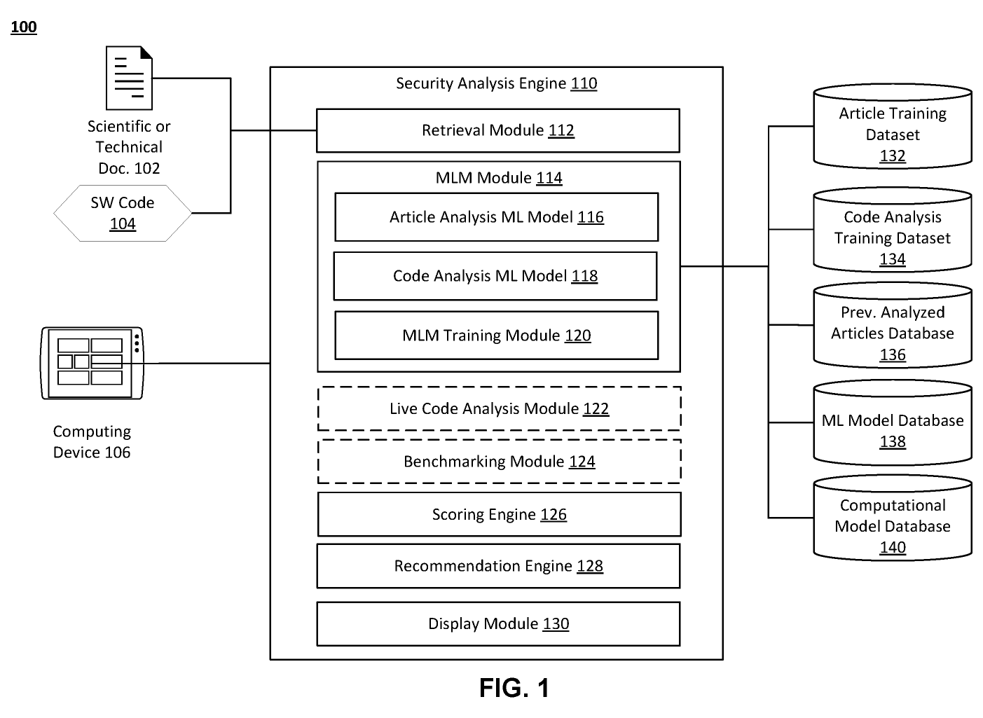

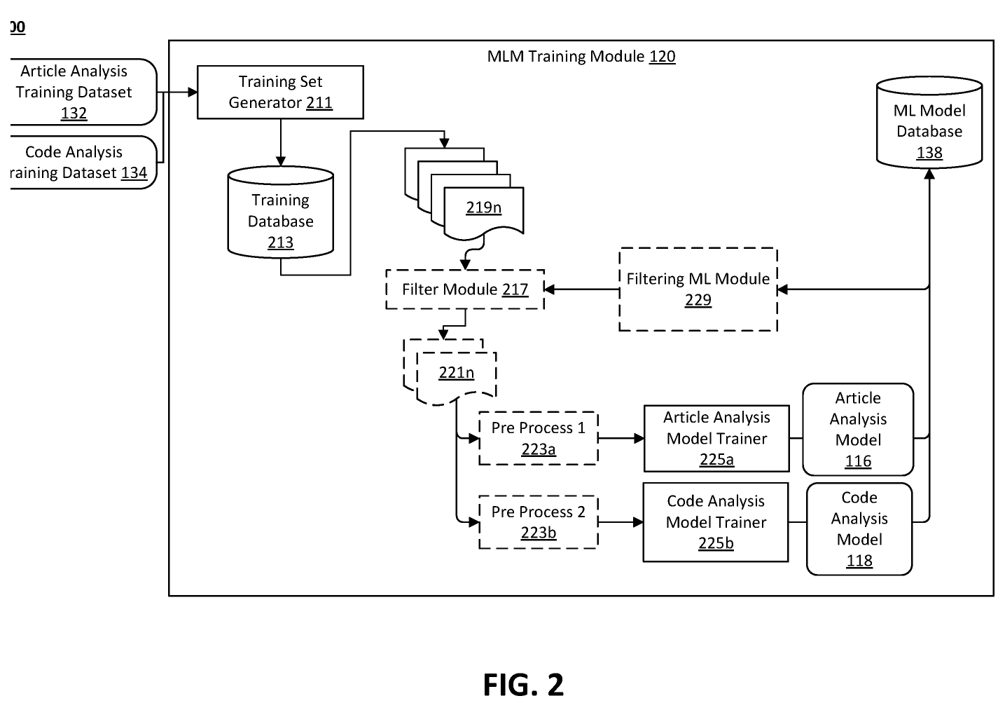

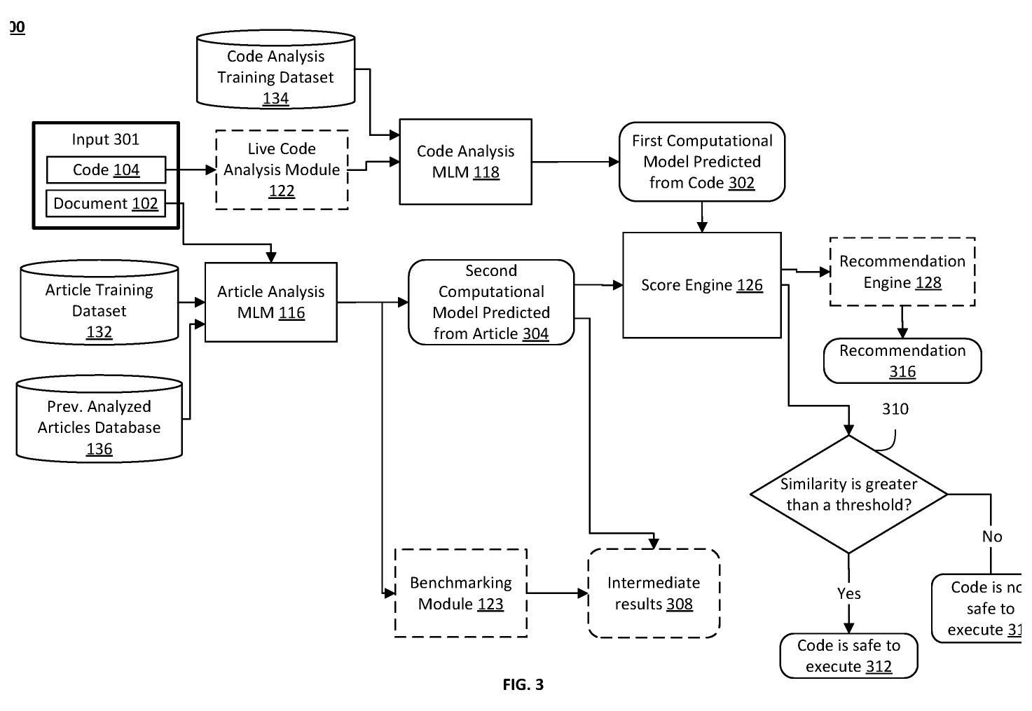

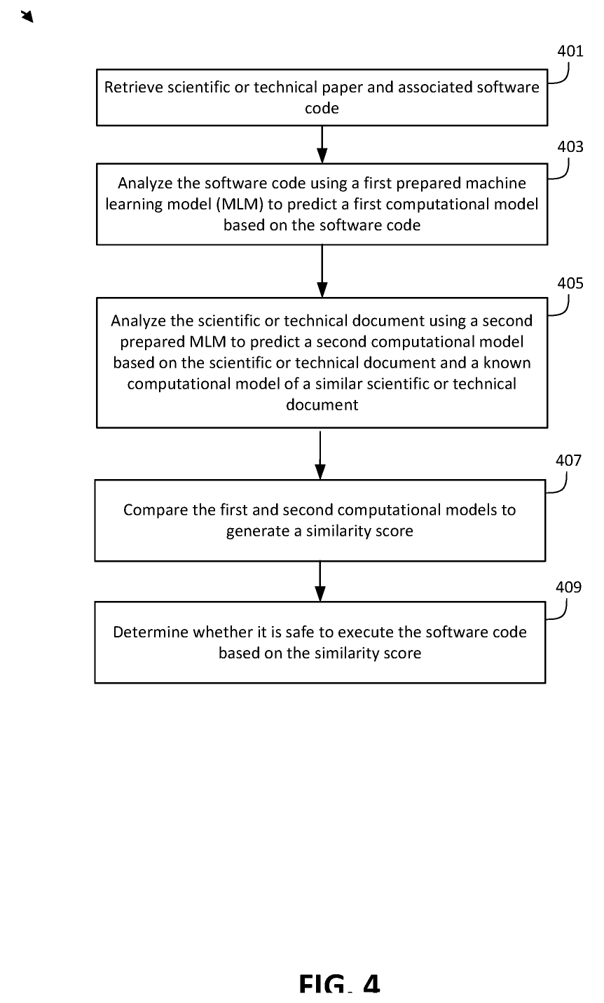

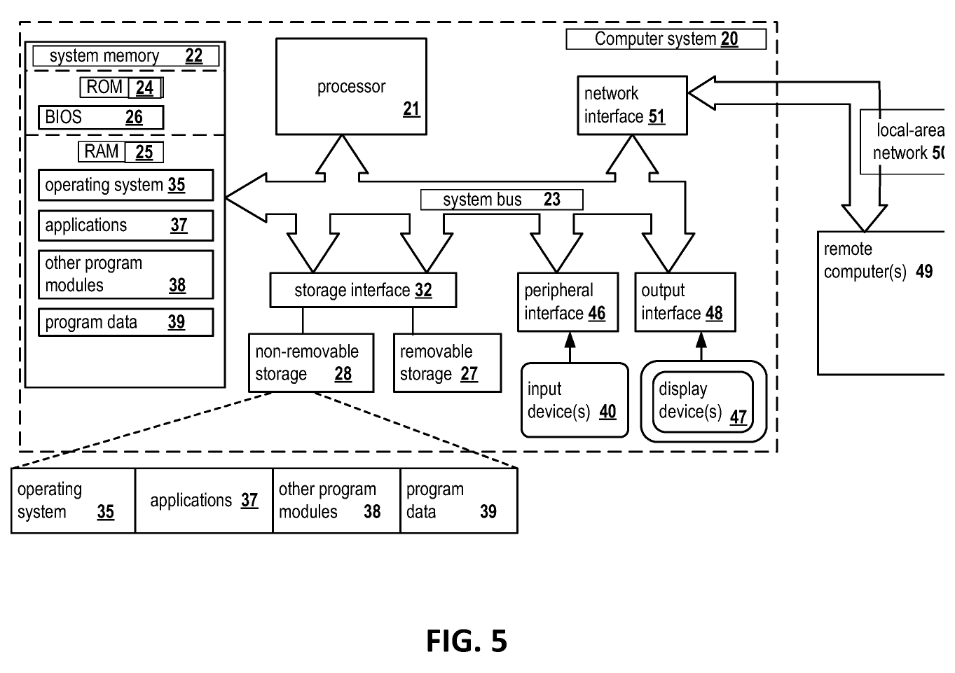

he accompanying drawings, which are incorporated into and constitute a part of this specification, illustrate one or more example aspects of the present disclosure and, together with the detailed description, serve to explain their principles and implementations. FIG. 1s a block diagram illustrating a system for analyzing safety of software code associated with scientific or technical documents without execution of the software code according to aspects of the present disclosure. FIG. 2s a block diagram illustrating a system for preparing machine learning models to analyze safety of software code associated with scientific or technical documents according to aspects of the present disclosure. FIG. 3s an example flowchart for performing an analysis of software code associated with a scientific or technical document without execution according to aspects of the present disclosure. FIG. 4 s an example method for preparing machine learning models to analyze safety of software code associated with scientific or technical documents before execution of the software code according to an aspect of the present disclosure. FIG. 5 resents an example of a general-purpose computer system on which aspects of the present disclosure can be implemented. ike reference numbers and designations in the various drawings indicate like elements.

### DETAILED DESCRIPTION

Exemplary aspects are described herein in the context of a system, method, and computer program product for analyzing safety of software code associated with scientific or technical documents without executing the software code. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

One of the fundamental problems addressed in this approach is using benchmarking of computational models to evaluate the safety of software code without executing the software code. The system relies on existing datasets to assess how similar a given scientific article is to previous studies, using this similarity as a basis for estimating computational needs. However, if an article is only 10% similar to related articles in the dataset but its corresponding code exhibits a 90% similarity match, this raises concerns about the validity of the computational model. Such inconsistencies lower the confidence in the result and suggest that additional verification is required before execution. Following on the above example, if the article describes a model for predicting solar flares with expected CPU and RAM utilization, but the corresponding code requires significantly more resources than predicted, this may also indicate the presence of inefficiencies, unnecessary computations, or hidden security vulnerabilities.

Another challenge arises from the way computational resources are allocated and predicted based on prior studies. When analyzing scientific computations—such as climate modeling, seismic activity predictions, or astrophysical simulations—a first machine learning model (MLM) may predict first computational parameters (otherwise known as computational models), including CPU and RAM utilization, the number of iterations required, and external data dependencies. A second MLM may predict second computational parameters based on known computational parameters for a similar article that has already been analyzed. If significant mismatches occur between the first computational parameters and the second computational parameters, which are predicted using different methodologies, it may indicate errors in the code, inefficiencies in algorithm implementation, or even unauthorized operations embedded within the software.

Conventional methods of ensuring software code safety before code execution involves a combination of static and dynamic analysis, security measures, testing, and environment management. Static analysis technique includes manual code reviews and automated static code analysis tools to help detect vulnerabilities and logical errors before execution. Formal verification methods may mathematically prove the correctness of software. Security measures like access control, code signing, and antivirus scanning help prevent unauthorized access and ensure the integrity of the software before it runs. Testing and validation play a crucial role in ensuring safety, with unit testing verifying individual components, integration testing ensuring system-wide compatibility, and regression testing detecting unintended changes. Dynamic analysis involves sandboxing, where code is executed in an isolated environment to prevent system damage, as well as fuzz testing, which introduces random inputs to uncover vulnerabilities. Additionally, runtime monitoring ensures that the software behaves as expected during execution.

However, while runtime monitoring is a valuable tool for security analysis, it has several drawbacks. One major issue is that it is reactive rather than preventive, meaning that it detects security threats as they occur rather than stopping them beforehand, allowing potential damage before intervention. Additionally, runtime monitoring requires executing the computation, which can sometimes take weeks at a time and can introduce performance overhead, consuming system resources like CPU, memory, and network bandwidth, which can slow down application performance. Another challenge is the occurrence of false positives and false negatives – false alarms can lead to unnecessary disruptions, while undetected threats may allow attacks to go unnoticed. Furthermore, the scope of detection is limited, as sophisticated threats like zero-day exploits or deeply embedded malware may bypass monitoring tools if they do not match predefined patterns. Implementing and maintaining an effective monitoring system also requires high expertise and continuous updates, making it complex and resource intensive. Additionally, insider threats pose a risk, as attackers with privileged access could manipulate logs, disable alerts, or bypass security measures. Lastly, even if a security threat is detected, response time may be delayed, and action might not be quick enough to prevent damage, especially in critical systems.

Ensuring safety in these applications requires not only a robust comparison framework but also an understanding of how benchmarking differences impact the final assessments. The benchmarking module helps quantify how closely an article matches prior articles and their corresponding software code and adjusts predictions accordingly. For example, if a study on seismic activity in California is compared against a similar study on the Greek island of Cyprus, differences in computational requirements must be considered, including variations in data history, processing hardware, and regional geological factors. Without accounting for these differences, the benchmarking may introduce inaccuracies in computational predictions, leading to incorrect predictions.

A first aspect of the present disclosure describes a method of utilizing a machine learning model (MLM) to perform code analysis for predicting a first computational models (e.g., first computational parameters) required for executing software code associated with a technical or scientific document based on analyzing similar projects. A second aspect of the present disclosure then utilizes a second MLM to perform article analysis on the technical or scientific document based on a comparison with previous similar articles to predict a second computational models (e.g., second computational parameters) that the software code should take. A third aspect of the present disclosure includes determining whether it is safe to execute the software code based on a similarity comparison of the first computational model and the second computational model. The principle behind the present disclosure is that if the first and second computational models are identical or similar, then the indication is that the software code shares similar characteristics with the expected potential code, confirming that the code is safe and functions are as intended without actually executing any of the software code.

The technical benefits of the present disclosure for performing safety analysis of software code by comparing predicted computational parameters includes improved accuracy, efficiency, and security based on predicting computational requirements using MLMs. By using MLMs (e.g., first MLM for code analysis and a second MLM for article analysis) to analyze both the code and its corresponding scientific article, the system may predict computational parameters such as CPU and RAM utilization, external data sources, and computational iterations. This also allows users to estimate resource requirements before execution, preventing inefficient or unsafe code from running.

Another key advantage of the present disclosure is its ability to detect discrepancies between the predicted computational models of the software code and the expected computational models derived from the article itself. If the two computational models align closely, then the software code is deemed safe and relevant to the article. However, significant mismatches – such as an article describing weather simulations while the associated software code unexpectedly accesses sensitive data- serve as red flags for potential security risks or misalignment. Additionally, benchmarking and similarity analysis may help assess how closely the article resembles previous research articles and make adjustments to the prediction of the computational parameter accordingly, improving the reliability of the predictions.

Furthermore, by eliminating the need for direct code execution, the present disclosure enhances security by preventing potentially harmful or inefficient code from being run in live environments. This is particularly valuable in fields where computations may take weeks or require extensive resources, such as climate modeling, astrophysics, and seismic activity predictions. The system also provides intermediate results and human feedback integration, allowing for manual verification and refinement of the predictions.

Ultimately, the present disclosure aims to establish a more reliable method for validating software code against scientific research without execution, ensuring that computational resources are accurately predicted, and potential security risks are identified early. By refining similarity criteria, enhancing benchmarking accuracy, and incorporating human feedback into the evaluation process, the system can improve its confidence in determining whether code is safe and corresponds to its intended scientific application.

FIG. 1 s a block diagram illustrating a system 100 configured to analyze the safety of software code associated with scientific or technical documents without execution of the software code. In one aspect, the components of system 100 may be implemented on computer systems, such as that shown in FIG. 5.

The system 100 may be used to perform security analysis of software code based on generating computational parameters by analyzing both software code and scientific or technical documents separately. Specifically, the security analysis engine 110 is configured to predict respective computational models using MLMs and determine whether the software code is safe to execute based on a similarity between the two predicted computational models. In this way, the security analysis engine 110 can quickly perform benchmarking to indicate whether predicted estimated parameters between the software code and article are similar.

The system 100 includes at least a scientific or technical document 102, software code 104 corresponding to the scientific or technical document 102, a computing device 106, a security analysis engine 110, and various databases (e.g., article training dataset 132, code analysis training dataset 134, previously analyzed articles database 136, MLM database 138, a computational model database 140). The security analysis engine 110 is configured to predict a first computational parameter based on analyzing the software code 104 and a second computational parameter based on analyzing the scientific or technical document 102 to determine whether the software code 104 is safe to execute. The computing device 106 may execute a plurality of modules in the security analysis engine 110 that together make up the collection, analysis, prediction, and determination system. In some aspects, the security analysis engine 110 may correspond to the computing device 106 or cloud network (not shown) that is configured to execute a plurality of modules that make up the security analysis engine 110.

In some aspects, the security analysis engine 110 may include a retrieval module 112, a MLM module 114 including at least an article analysis MLM 116, a code analysis MLM 118, and a MLM training module 120, an optional live code analysis module 122, an optional benchmarking module 123, a scoring engine 126, a recommendation engine 128, and a display module 130. In some aspects, training data for the MLM training module 120 may be stored in the article training dataset 132, the code analysis training dataset 134, the previous analyzed articles database 136. In some aspects, the article analysis MLM 116 and the code analysis MLM 118 may be stored on the MLM database 138.

In some aspects, the computing device 106 may execute a retrieval module 112 configured to retrieve the scientific or technical document 102 and the software code 104 associated with the scientific or technical document 102. The software code 104 may include executable code and/or source code. In some aspects, the retrieval module 112 may access the previously analyzed articles database 136, the MLM model database 138, and/or the computational model database 140. In some aspects, the retrieval module 112 may access the scientific or technical document 102 and the associated software code 104 from the internet or any other suitable sources.

In some aspects, the computing device 106 may execute a MLM module 114 including an article analysis MLM 116, a code analysis MLM 118, and a MLM training module 120. The code analysis MLM 118 is configured to predict a first computational model based on the software code 104 such that the first computational model indicates computational resources and/or data sources utilized for execution of the software code 104. The article analysis MLM 116 is configured to predict a second computational model based on the scientific or technical document 102 and a known computational model of a similar scientific or technical document. As will be described in more detail with respect FIG. 2, the MLM training module 120 is configured to train the article analysis MLM 116 and the code analysis MLM 118. In some aspects, the article analysis MLM 116 and the code analysis MLM 118 may contain specifically trained MLMs. For illustrative purposes, the present disclosure will describe the MLM as an LLM, but those of ordinary skill in the industry will recognize that any suitable type of MLM may be utilized in the present disclosure.

A LLM is a type of AI designed to understand and generate human language. LLMs are trained on vast amounts of text data, enabling it to perform a wide range of language-related tasks such as answering questions, summarizing text, translating languages, or generating content. LLMS, similar to generative pretrained transformer (GPT), use deep learning techniques to recognize patterns, learn context, and predict word sequences making them highly versatile in natural language processing applications. Accordingly, the computing device 106 may execute the MLM training module 120 to train the LLMs in the article analysis MLM 116 and the code analysis MLM 118 to teach the MLMs to perform their respective specific tasks. Further details about the training of each respective MLM will be described in further detail in FIG. 2.

A transformer is a deep learning architecture used in LLMs. The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, and image classification and generation. Common examples of transformer models are GPT and Bidirectional Encoder Representations from Transformers (BERT).

For analysis tasks such as analyzing the scientific or technical document 102, an unprepared article analysis MLM 116 will first analyze data from an article training dataset 132 and/or a document analysis training dataset to “learn” how to find similar scientific or technical document from the previously analyzed articles database 136 in order to predict a computational model based on the contents of the scientific or technical document 102. The process may begin with analyzing the scientific or technical document 102 alongside a known computational model derived from a similar document. This may involves extracting relevant features such as structural patterns, referenced computational methodologies, and dependencies within the document. The article analysis MLM 116 is then trained to recognize correlations between these features and the computational resources and data sources utilized in the known model using an analysis training dataset 132.

By leveraging supervised or semi-supervised learning techniques, the article analysis MLM 116 learns to generalize patterns that map document content to computational execution requirements. Once trained, the article analysis MLM 116 can predict the computational resources and data sources necessary for executing software code associated with the scientific or technical document 102, thereby facilitating the automation of computational model generation for new technical documents.

During training of the article analysis MLM 116, the results from the untrained MLM are then compared with known data set results using the corresponding ground truth labels for a document analysis training dataset, a code training dataset, and a computational parameter training dataset. It should be noted that the input to the trained/prepared article analysis MLM 116 will be data from the document analysis training dataset 132. As an example, the document analysis training dataset 132 may include at least: (a) a training documents dataset comprising at least text of training documents and metadata to enable similarity analysis and prediction, wherein the training documents dataset is labeled and annotated to identify a subject matter to group documents, (b) a code training dataset comprising at least source code associated with the training documents and metadata corresponding to features of source code to capture features from code associated with the training documents to provide execution context, (c) a computational parameter training dataset comprising at least execution settings and execution logs to provide ground truth labels for computational parameters required for execution, (d) a similarity training dataset comprising at least document similarity pairs, code similarity pairs, and cross-mapping data to establish relationships between documents based on similarity and associated execution parameters, and (e) ground truth labels for the training documents dataset, the code training dataset, the computational parameter training dataset.

For every input training sample from the document analysis training dataset 132, the prepared article analysis MLM 116 will produce a prediction consisting of values representing a probability that computational resources and/or data sources utilized for execution of the software code 104 is accurate with respect to a known computational model from the computational model database 140. The output with the highest probability determines the identification. A class label for each answer may be used to compute a loss (e.g., loss function).

The trained article analysis MLM 116 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks.

Once the MLM is trained (e.g., inference), the trained article analysis MLM 116 may predict a computational model for executing software code associated with the scientific or technical document 102 based on a known computational model for a previously analyzed scientific or technical paper that is similar to the scientific or technical document 102.

During inference, the trained article analysis MLM 116 does not re-evaluate or adjust the layers of the neural network based on the results. Instead, the inference applies knowledge from the trained neural network and uses it to infer a result. Accordingly, when a new unknown dataset (e.g., unknown scientific or technical paper) is input through the trained article analysis MLM 116, the trained MLM outputs a predicted computational model for the scientific or technical document 102 based on the predictive accuracy of the MLM.

Similarly, during preparation (e.g., training) of the code analysis MLM 118 to predict a computational model based on the software code 104, the process also involves analyzing the structure, dependencies, and execution patterns of the software code 104. The code analysis MLM 118 is trained on labeled datasets containing code samples mapped to their corresponding computational resources and data sources used during execution. Feature extraction techniques, such as static and dynamic code analysis, are employed to identify function calls, libraries, memory usage, and data flow patterns. By learning these correlations, the code analysis MLM 118 can predict the computational resources and data sources required for executing new software code, enabling efficient resource allocation and execution planning.

The code analysis training dataset 134 for the code analysis MLM 118 may include at least: (a) a code training dataset comprising at least source code and metadata corresponding to features for the source code to extract patterns that predict computational parameters, (b) a computational parameter training dataset comprising at least data requirement information and execution configuration information to provide ground truth labels for computational parameters required for execution, (c) a code-document interaction training dataset comprising at least annotations, mapping rules, and execution example logs to provide additional context about how the software code was executed, and (d) ground truth labels for the code training dataset, the computational parameter training dataset, and the code-document interaction training dataset to serve as a target output for the code analysis MLM 118.

In some aspects, the code analysis MLM 118 may be trained based on a public training dataset such as GitHub repositories. The process begins with data collection, where large-scale open-source codebases are extracted, including metadata on computational resources (e.g., CPU, GPU usage) and data sources (e.g., APIs, databases) referenced in execution. Feature extraction techniques, such as tokenization, abstract syntax tree (AST) analysis, and embedding models like CodeBERT, are applied to represent the software code in a structured manner. The code analysis MLM 118 is then trained using supervised learning, where labeled examples of software code and their corresponding computational models serve as training pairs. Techniques such as sequence-to-sequence models, graph neural networks (GNNs), or transformer-based architectures are employed to learn patterns in how computational resources and data sources are utilized. The model is fine-tuned through loss optimization and validation against a test set to improve prediction accuracy. Once trained, the code analysis MLM 118 can analyze new software code and predict the associated computational model, enabling automated resource estimation, optimization, and efficient deployment planning.

For every input training sample from the code analysis training dataset 134, the prepared code analysis MLM 118 may produce a prediction consisting of values representing a probability that a computational resource and/or data source to be utilized when executing the software code 104 is identified based on the software code 104. The output with the highest probability determines the predicted computational model for the software code 104.

In some aspects, an optimizer such as Adam or SGD may be used to train the models in the article analysis MLM 116 and the code analysis MLM 118. In some aspects, the data may be split into training, validation, and test sets. In these aspects, the article analysis MLM 116 and the code analysis MLM 118 are trained on the training dataset and then validated by the validation sets to tune hyperparameters.

The computing device 106 may execute the optional live code analysis module 122 to extract live portions of code from the software code 104 associated with the scientific or technical document 102. Live portions of code may correspond to segments of code that is actively executing, updating, or responding in real-time within a system. This process can be achieved through leveraging static analysis techniques such as AST analysis, control flow analysis, and dependency graph extraction, to identify segments of code that are designed to execute, update, or respond in real-time. By analyzing function calls, event listeners, concurrency patterns, and/or system interactions, relevant live portions can be inferred without actually executing the software code. These extracted segments are then processed using the code analysis MLM 118, which has been prepared to generate computational models based on code structure, annotations, and historical execution data. This approach enables insight into real-time execution characteristics without requiring actual runtime execution, ensuring efficiency and safety in environments where execution may be constrained or impractical.

The computing device 106 may execute the optional benchmarking module 123 to assess the similarity between the scientific or technical document 102 and other previously analyzed scientific or technical paper in the previously analyzed articles database 136. The benchmarking module 123 accounts for the fact that articles from the previously analyzed articles database 136 may not be completely similar to the scientific or technical document 102. For example, if the previously analyzed document from the previously analyzed articles database 136 is different than the scientific or technical document 102 then this benchmarking should be factored when predicting the second computational model 304 based on the previously analyzed document. This process involves extracting key features such as textual content, citations, keywords, and semantic structures, which are then compared using similarity metrics or machine learning-based models. By generating a similarity score, the benchmarking module helps identify related research, detect potential redundancies, and uncover new insights based on prior work.

As an example, the scientific or technical document 102 may involve computing seismic activity in California over the past one hundred years to predict future earthquakes and the most similar article may be focused on seismic patterns on the Greek island of Cyprus over fifty years. However, since the Greek island of Cyprus differs from California in many ways such as geography, size, and tectonic conditions, these differences should be accounted for. In addition, the study on the Greek island of Cyprus only covered a fifty year old period, meaning that the computational model may be off by at least 50%. Another key difference may be processing power since the software code associated with the Greek study may have taken a full week to process on CPUs from 2008 and the system may now leverage new more powerful CPUs, which may be approximately five times more powerful. This hardware upgrade may partially offset some discrepancies, but the benchmark error margin remains significant. Given these factors (e.g., the differences between California and Cyprus, the limited timeframe of data, and the computational advancements), the final predictive accuracy provided by the article analysis MLM 116 may need to be calibrated (e.g., scaled) to ensure reliability in its prediction.

The computing device 106 may also execute the optional computational benchmarking module 124 to modify one or more computational resources of the known computational model based on the similarity benchmark to predict corresponding computational resource for the second computational model. The similarity benchmark is derived by comparing key attributes such as data dependencies, processing requirements, execution patterns, and resource utilization. Based on this benchmark, adjustments are made to the computational resources of the known model—such as modifying memory allocation, processing units, or data sources—to predict the corresponding computational resources needed for the computational model based on similar articles (e.g., second computational model). This adaptive modification ensures that the second computational model is optimized for accurate execution while maintaining alignment with the computational characteristics of the known model.

An example of modifying computational resources based on a similarity benchmark can be seen in the adaptation of machine learning training infrastructure for a new but similar model. Suppose a known computational model was used to train a deep learning model on medical imaging data using a GPU cluster with 32GB of VRAM, high-speed SSD storage, and a cloud-based dataset. Now, a new deep learning model needs to be trained for a different but similar medical imaging dataset with slightly higher resolution images and additional metadata. Using a similarity benchmark—comparing factors such as dataset size, model complexity, and memory requirements—the computational resources from the known model can be modified. For instance, based on the similarity analysis, it may be determined that the new model requires GPUs with 40GB of VRAM to handle the increased image resolution efficiently. Additionally, if the new dataset includes more metadata processing, adjustments might be made to increase RAM allocation or switch to a different database optimized for structured metadata queries. Thus, by modifying these computational resources based on the similarity benchmark, the system 100 can predict the most appropriate resource configuration for the second computational model, ensuring optimal performance without redundant over-provisioning.

The computing device 106 may execute the scoring engine 126 to generate a similarity score between the computational model based on the code analysis (e.g., first computational model) and the computational model based on the article analysis (e.g., second computational model). The scoring engine 126 may be configured to compare the first and second computational models to generate a similarity score operates by analyzing key attributes of each model, such as computational resource requirements, data dependencies, execution patterns, and structural components. The scoring engine 126 may utilize predefined metrics, such as cosine similarity, Euclidean distance, or machine learning-based feature embeddings, to quantify the degree of resemblance between the models. By extracting relevant parameters—such as memory usage, processing units, storage needs, and data sources—the engine computes a similarity score that reflects how closely the second computational model aligns with the first.

The computing device 106 may execute the recommendation engine 128 configured to determine whether it is safe to execute the software code 104 based on the similarity score operates by assessing the computational requirements of potential computational models that could be used to perform calculations related to the scientific or technical document 102. The recommendation engine 128 engine evaluates a first predicted computational model for this potential code and compares it to a second predicted computational model based on a known computational model with established characteristics. If the similarity score between the first and second computational models is high, then this may indicate that the computational characteristics of the potential code align with those of previously validated code, suggesting that code execution is safe in terms of security. If the similarity score between the first and second computational models is low, then this may indicate that the computational characteristics of the potential code do not align with those of previously validated code, suggesting that the code execution may be suspicious. This approach ensures that the system 100 does not execute code with unpredictable or excessive resource demands, while also verifying that the computational infrastructure is suitable for the expected operations. By focusing on computational model similarity alignment rather than direct code execution, the recommendation engine provides a robust safety mechanism for computational resource allocation and execution feasibility.

The computing device 106 may execute the display module 130 to generate and display the results of the predicted first and second computational models and/or the comparison of the predicted first and second computational models. Generally, the display module 130 is responsible for managing and rendering the visual components of the user interface by handling the presentation of information to the user, ensuring that data and controls are displayed correctly and consistently across the UI.

In some aspects, the display module 130 is configured to render or draw all the elements of the UI, such as windows, buttons, text fields, menus, icons, images, and other components. In some aspects, the display module 130 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 130 may be considered the “view” part of a model-view-controller (MVC) or similar design pattern. It serves as the layer that presents data to the user and receives input to and from the computing device 106.

It should be noted that the analysis and generation of the computational models described in the present disclosure are heavily simplified. One skilled in the art will appreciate that the MLMs utilized may have significantly large datasets with highly specific details due to the complexity and scale of modern software systems. Computational models involve numerous interdependent factors, such as memory allocation, processing power, parallel execution, I/O operations, and external data dependencies, all of which require intricate calculations and cross-referencing vast amounts of technical details. Human cognition is limited in its ability to manually track and analyze these dependencies with the precision and efficiency required for accurate predictions. Furthermore, software code often includes dynamic execution behaviors, runtime optimizations, and external API interactions that cannot be fully anticipated without automated analysis. Machine learning models excel in recognizing patterns, processing large datasets, and making data-driven predictions, enabling them to analyze software code efficiently and generate reliable computational models in a way that manual methods simply cannot achieve within a reasonable timeframe.

FIG. 2 is a block diagram illustrating a system for analyzing safety of software code associated with scientific or technical documents without execution of the software code according to aspects of the present disclosure. As shown in example 200, the MLM training module 120 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled training data sets, the specialized machine learning models may perform particular tasks such as predicting a first computational model based on software code and predict a second computational model based on a known computational model for a document similar to the scientific or technical document.

Supervised learning is effective for tasks such as classification (assigning inputs to predefined categories) and regression (predicting continuous values) since it relies on the availability of labeled data for both training and evaluation phases. In supervised learning, the MLM training module 120 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the MLM training module 120 provides the algorithm with a training dataset including input-output pairs. The algorithm learns the mapping function that relates inputs to outputs through an iterative process, adjusting its internal parameters based on the provided examples.

During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 120 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM training module 120 includes at least a training database 213 configured to store the raw training data 219n and corresponding labels (e.g., article training dataset 132, code analysis training dataset, and/or previous analyzed articles database 136), a MLM database 138 to store the trained models (e.g., the prepared article analysis MLM 116 and the code analysis MLM 118). In some aspects, the MLM training module 120 may include an optional filtering ML module 229 and an optional filter module 217 configured to filter data from the training database 213 for training by removing poorly generated training data.

Training data from an article analysis training dataset 132 and a code analysis training dataset 134 is received into the MLM training module 120 via the training set generator 211. Details about the data included in each training dataset is described in more detail above with FIG. 1.

An optional filtering ML module 229 is configured to filter out bad training data to clean up the training data in the training dataset 219n. In some examples, the optional filter module 217 may be a neural network. In some examples, the optional filter module 217 is a mathematical model. In some examples, the cleaned training dataset 221n then undergoes optional preprocessing steps depending on which neural network or model is being trained.

The optional preprocess 1 223a and preprocess 2 223b are automated processes that modify the raw data received from 219n (or cleaned training dataset 221n) and prepare the raw data as input to the respective model trainers (e.g., article analysis model trainer 225a and code analysis model trainer 225b). These may be described in the MLM training module 120 as snippets of code that prepares the datasets. In some examples, the preprocessing module (e.g., preprocess 1 223a and preprocess 2 223b) for a particular trainer may be an automated script or code that will be setup the first time any model is trained.

The article analysis model trainer 225a and/or the code analysis model trainer 225b are the scripts or code that train the respective models. The article analysis model trainer 225a and/or the code analysis model trainer 225b may be a script or code that holds the instructions on how a model should be trained (e.g., optimization method, model architecture, dataset division, etc.) and also runs the training. The article analysis model trainer 225a and/or the code analysis model trainer 225b each take as input the raw or filtered processed training data and train the article analysis model trainer 225a and/or the code analysis model trainer 225b to achieve their specific objectives, respectively.

In summary, the raw dataset 219n or cleaned dataset 221n may optionally go through different preprocessing steps 223a, 223b, and then a corresponding article analysis model trainer 225a and/or code analysis model trainer 225b to generate a prepared article analysis MLM 116 and a code analysis MLM 118. In some examples, each of these models may be a MLM or a neural network.

As a non-limiting example and as discussed above, the machine learning may be a neural network. The neural network models are designed using a set of hyperparameters that define high-level aspects of their architecture and training process. These hyperparameters include but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 219n used for training may include noise and bad training data from the training database 132. Accordingly, to create a clean and filtered training dataset, the optional filter module 217 is configured to filter out unwanted data points from the raw training dataset 219n by developing smaller, less accurate systems based on patterns and metadata information.

During the training process, the article analysis model trainer 225a and the code analysis model trainer 225b are presented with input data and labels of actual values, and the optimization objective, which aims to minimize the difference between the actual value and the predicted value, is calculated. The optimization algorithm updates the parameters of the article analysis model trainer 225a and the code analysis model trainer 225b to reduce the value of the objective. This process is repeated for several iterations until the parameters do not change anymore. This process is repeated for various combinations of hyperparameters, and the model with the smallest label prediction error is selected as the final model.

When a new model (e.g., the prepared article analysis MLM 116 and the prepared code analysis MLM 118) is created, and a new process for filtering and automated labeling is established, it is added to the MLM database 138 in the MLM training module 120. This enables the new model to be part of the closed-loop model update process. Optionally, at regular intervals, data which is continuously collected can be filtered, labeled, and used to update old models by an optional filtering ML module 229. In some examples, the optional filtering ML module 229 is a neural network. In some examples, the optional filtering ML module 229 is a mathematical model. This approach may capture changes in the data over time.

FIG. 3 is an example flowchart for performing an analysis of software code associated with a scientific or technical document without execution according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). The method 300 describes a method of performing an analysis of software code associated with a scientific or technical document without execution according to aspects of the present disclosure.

The method 300 begins obtaining a scientific or technical document 102 and software code 104 associated with the scientific or technical document 102 (collectively, the input 301).

The code analysis MLM 118 is prepared by using a code analysis training dataset 134 to predict a first computational model 302 predicted from the code based on analyzing the software code 104. The first computational model 302 indicates computational resources and/or data sources utilized when executing the software code. It is important to note that the code analysis MLM 118 does not execute software code, but merely analyzes the software code.

The computational model may define the parameters and resource requirements necessary for executing a given computation in the software code 104. It may include data sources, such as external databases or real-time inputs, as well as hardware specifications like CPU, GPU, and RAM, which determine processing capability. The computational model also accounts for iterations, specifying the number of computational cycles needed to achieve results, along with resource consumption and its variations based on workload complexity. For example, more iterations of loop functions will result in more resource consumption.

Optionally, in some aspects, the software code 104 may be analyzed by an optional live code analysis module 122 to extract live portions of code from the software code 104. The live portions of code corresponds to segments of code that will be actively executing, updating, or responding in real-time within a system. In this case, the optional live code analysis module 122 may perform live code analysis and determine code coverage without executing the software code using static analysis techniques. Static analysis inspects the software code 104 to infer which portions of the code are likely to be executed without actually running the program.

The optional live code analysis module 122 may execute any variety of static analysis techniques to extract live portions of code. One approach is abstract interpretation, which uses mathematical approximations to infer execution paths. Control Flow Analysis (CFA) constructs a Control Flow Graph (CFG) to identify reachable branches based on code structure, while Data Flow Analysis (DFA) tracks data movement to determine dependencies and variable usage. Symbolic execution explores different execution paths by replacing concrete values with symbolic variables, enabling branch reachability assessment. Additionally, code heuristics and pattern matching can identify dynamic code patterns such as event listeners and loops, while dependency analysis examines interactions between modules to infer live code segments. Advanced techniques, such as static profiling with AI and machine learning, use historical execution data and structural feature extraction to predict likely active code. By analyzing the software code 104 in this manner, the optional live code analysis module 122 can distinguish dynamic and responsive components from static code, enabling the system to focus on live code rather than the entire code.

The prepared code analysis MLM 118 then analyzes the software code 104 (or extracted live portions of the software code 104) to predict the first computational model 302 predicted from code. This involves leveraging trained machine learning algorithms to recognize patterns, structures, and execution behaviors within the code. By analyzing syntax, control flow, and functional dependencies, the code MLM 118 can infer how the software is likely to behave under various conditions, generating a predictive computational model that represents its execution dynamics.

The article analysis MLM 116 is prepared by using the article training dataset 132 to predict a second computational model 304 predicted from the article based on analyzing the scientific or technical document 102 and known computational models of similar articles to the scientific or technical document 102 from the previously analyzed articles database 136.

The prepared article analysis MLM 116 then analyzes the scientific or technical document 102 to predict a second computational model 304 predicted from the article based on a known computational model of a similar scientific or technical document from the previously analyzed articles database 136. This process enables the system to infer computational methods that are likely relevant to the new document, even if they are not explicitly stated. By leveraging previously analyzed documents, the MLM 116 identifies patterns and relationships between scientific concepts and computational models, improving the accuracy and relevance of model predictions.

In some aspects, the prepared article analysis MLM 116 may generate a similarity score between the scientific or technical document 102 and the similar scientific or technical document from the previously analyzed articles database 136 using the optional benchmarking module 123 to calibrate the prediction. For example, if the scientific or technical document is very similar to another scientific or technical document identified from the previously analyzed articles dataset 136, then the similarity criteria will be high and the second computational model 304 generated by the prepared article analysis MLM 116 should be fairly accurate. As another example, if the scientific or technical document is not similar to another scientific or technical document identified from the previously analyzed articles dataset 136, the similarity criteria will be low and the second computational model 304 generated by the prepared article analysis MLM 116 will probably not be accurate because there is no similar known computational model for the prepared article analysis MLM 116.

In some aspects, the method 300 may include displaying intermediate results 308 of the second computational model 304 and/or the similarity criteria. This allows for real-time analysis and validation of the prepared article analysis MLM’s 116 predictions, enabling users to monitor its progression and make adjustments as needed. In some aspects, the intermediate results 308 may inform the users that the comparisons of computational models is not similar. In some aspects, the intermediate results 308 may inform the users that the comparisons of computational models is similar. By visualizing intermediate outputs, researchers and developers can gain insights into how the model is interpreting the scientific or technical document, improving transparency and accuracy. Additionally, displaying similarity criteria helps in assessing the relevance and alignment of the predicted model with existing computational models, enhancing decision-making and refinement processes.

The method 300 then includes comparing the first computational model 302 predicted from the software code 104 with the second computational model predicted from the scientific or technical document 102 using a scoring engine 126 to generate a similarity score. This process involves analyzing key characteristics, parameters, or outputs of both models to identify patterns, correlations, or deviations. The engine applies computational techniques such as cosine similarity, Euclidean distance, or machine learning-based comparison methods to quantify the degree of resemblance. Once the evaluation is complete, the similarity score is generated, providing a numerical representation of how closely the two models align. This similarity score can then be used for further analysis, decision-making, or model validation processes.

In some aspects, the comparison between the first computational model 302 predicted from the software code 104 and the second computational model predicted from the scientific or technical document 102 is performed using analytics. In this case, the scoring engine utilizing analytics operates by systematically evaluating and comparing computational models though a series of data-driven techniques. The process begins with data preprocessing, where relevant features from both models are extracted, normalized, and transformed for consistency. Analytical techniques such as principal component analysis (PCA), clustering, and statistical correlation are then applied to identify key distinguishing attributes. Similarity metrics, including cosine similarity, Euclidean distance, or Jaccard index, are used to quantify the degree of resemblance between the models. Advanced machine learning techniques, such as deep learning or anomaly detection, may further refine the comparison by detecting complex patterns and relationships. Once the similarity score is computed, predictive analytics and statistical models interpret the results to provide insights into model alignment, divergence, and potential areas for improvement. Additionally, the scoring engine can incorporate real-time analytics to continuously monitor model performance and adapt its evaluation criteria dynamically.

In some aspects, the comparison between the first computational model 302 predicted from the software code 104 and the second computational model predicted from the scientific or technical document 102 is performed using machine learning. In this case, the scoring engine using machine learning techniques operates by extracting and preprocessing features from computational models, ensuring consistency for comparison. It employs supervised learning (e.g., neural networks, SVMs) for labeled similarity prediction, unsupervised methods (e.g., clustering, anomaly detection) for pattern recognition, and reinforcement learning for adaptive refinement. The engine leverages similarity metrics like cosine similarity or Euclidean distance, often enhanced by deep learning-based embeddings.

In some aspects, the scoring engine may also evaluate whether the similarity score is greater than a threshold 310. Based on a determination that the similarity score is greater than a threshold, then the method 300 may determine that the software code 104 is safe to execute 312. Based on a determination that the similarity score is less than the threshold, then the method 300 may determine that the software code 104 is not safe to execute 314.

In some aspects, the method 300 may include inputting the similarity score into a recommendation engine 128 to generate a recommendation 316. In some aspects, if the similarity score is greater than a first threshold, then the recommendation 316 may be to execute the software code 104. In some aspects, if the similarity score is less than a second threshold, then the recommendation may be to not execute the software code. In some aspects, if the similarity score is between the first threshold and the second threshold, then the recommendation may be to notify a security officer.

FIG. 4 is an example method for preparing machine learning models to analyze safety of software code associated with scientific or technical documents before execution of the software code according to an aspect of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 describes a method of analyzing the safety of software code associated with scientific or technical documents before execution of the software code according to aspects of the present disclosure.

At 401, the method 400 may include receiving a scientific or technical document and software code associated with the scientific or technical document. The software code may include executable code and/or source code. As an example, referring back to FIGS. 1 and 3, the retrieval module 112 may retrieve a scientific or technical document 102 and corresponding software code 104.

In some aspects, the method 400 may include extracting live portions of code from the software code associated with the scientific or technical document and analyzing the extracted live portions of code using the first prepared MLM. The live portion may correspond to segment of code that is actively executing, updating, or responding in real-time within a system. As an example, referring back to FIGS. 1 and 3, the optional live code analysis module 122 may extract live portions of code from the software code associated with the scientific or technical document.

At 403, the method 400 may include analyzing the software code using a first prepared machine learning model (e.g., the code analysis MLM 118 from FIGS. 1-3) to predict a first computational parameters (e.g., model) based on the software code. The first computational model may indicate computational resources and/or data sources utilized for execution of the software code. In some aspects, wherein computational resources may include one or more of: outside resources used in computation, processor utilization, memory utilization, number of computational iterations, or duration of the computation, and/or network utilization.

At 405, the method 400 may include analyzing the scientific or technical document using a second prepared MLM (e.g., the article analysis MLM 116 from FIGS. 1-3) to predict a second computational model based on the scientific or technical document and a known computational model of a similar scientific or technical document. The second computational model may indicate computational resources and/or data sources utilized for potential execution of the software code for performing calculations in the scientific or technical document. As an example, referring back to FIGS. 1 and 3, the code analysis MLM 118 may generate a first computational model 302 predicted from the code.

In some aspects, analyzing the scientific or technical document using the second prepared MLM may comprise: using the second prepared MLM to identify, in a database of previously analyzed scientific or technical documents and associated software codes, at least one scientific or technical document substantially similar to the received scientific or technical document; for the identified similar document, retrieving from the database, the known computational model based on the software code associated with the similar document; and using the second prepared MLM to predict the second computational model based on the known computational model and differences between the received document and similar document. As an example, referring back to FIGS. 1 and 3, the article analysis MLM 116 may generate a second computational model 304 predicted from the article.

In some aspects, wherein using the second prepared MLM to predict the second computation model based on the known computational model and differences between the received document and the similar document may further comprises: determining a document similarity benchmark based on comparison of the received document and the similar document using the second prepared MLM, wherein the similarity benchmark indicates degree of similarity of the compared documents; and modifying one or more computational resources of the known computational model based on the similarity benchmark to predict corresponding computational resource for the second computational model.

At 407, the method 400 may include comparing the first and second computational models to generate a similarity score. As an example, referring back to FIGS. 1 and 3, the scoring engine 126 may compare the first and second computational models to generate the similarity score.

At 409, the method 400 may include determining whether it is safe to execute the software code based on the similarity score. As an example, referring back to FIGS. 1 and 3, the recommendation engine 128 may determine whether it is safe to execute the software code 104 based on the generated similarity score.

In some aspects, determining whether it is safe to execute the software code based on the similarity score may further include: when the similarity score is above a first threshold, determining that it is safe to execute the software code and generating a recommendation to execute the software code to a user, when the similarity score is below a second threshold, determining that it is unsafe to execute the software code and generating a recommendation to not execute the software code to the user, and when the similarity score is between the first and second thresholds, generating a recommendation review the software code to the user.

In some aspects, the method 400 may include preparing the first MLM by: (1) providing, to the first MLM, a code analysis training dataset comprising at least: (a) a code training dataset comprising at least source code and metadata corresponding to features for the source code to extract patterns that predict computational parameters, (b) a computational parameter training dataset comprising at least data requirement information and execution configuration information to provide ground truth labels for computational parameters required for execution, (c) a code-document interaction training dataset comprising at least annotations, mapping rules, and execution example logs to provide additional context about how the software code was executed, and (d) ground truth labels for the code training dataset, the computational parameter training dataset, and the code-document interaction training dataset to serve as a target output for the first MLM; and (2) preparing the first MLM using the code analysis training dataset. As an example, referring back to FIGS. 1-3, the MLM training module 120 may be configured to prepare the article analysis MLM 116.

In some aspects, the method 400 may include: preparing the second MLM by: (1) providing, to the second MLM, a document analysis training dataset comprising at least: (a) a training documents dataset comprising at least text of training documents and metadata to enable similarity analysis and prediction, wherein the training documents dataset is labeled and annotated to identify a subject matter to group documents, (b) a code training dataset comprising at least source code associated with the training documents and metadata corresponding to features of source code to capture features from code associated with the training documents to provide execution context, (c) a computational parameter training dataset comprising at least execution settings and execution logs to provide ground truth labels for computational parameters required for execution, (d) a similarity training dataset comprising at least document similarity pairs, code similarity pairs, and cross-mapping data to establish relationships between documents based on similarity and associated execution parameters, (e) ground truth labels for the training documents dataset, the code training dataset, the computational parameter training dataset, and the similarity training dataset to serve as a target output for the second MLM; and (2) preparing the second MLM using the document analysis training dataset. As an example, referring back to FIGS. 1-3, the MLM training module 120 may be configured to prepare the code analysis MLM 118.

FIG. 5 represents an example of a general-purpose computer system on which aspects of the present disclosure can be implemented.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for analyzing safety of software code associated with scientific or technical documents before execution of the software code, the method comprising:
receiving a scientific or technical document and software code associated with the scientific or technical document, wherein the software code comprises executable code and/or source code;
analyzing the software code using a first prepared machine learning model (MLM) to predict a first computational parameters based on the software code, wherein the first computational parameters indicates computational resources and/or data sources utilized for execution of the software code;
analyzing the scientific or technical document using a second prepared MLM to predict a second computational parameters based on the scientific or technical document and a known computational parameters of a similar scientific or technical document, wherein the second computational parameters indicates computational resources and/or data sources utilized for potential execution of the software code for performing calculations in the scientific or technical document;
comparing the first and second computational parameters to generate a similarity score; and
determining whether it is safe to execute the software code based on the similarity score.

2. The method of claim 1, wherein analyzing the scientific or technical document using a second prepared MLM comprises:
using the second prepared MLM to identify, in a database of previously analyzed scientific or technical documents and associated software codes, at least one scientific or technical document substantially similar to the received scientific or technical document;
for the identified similar document, retrieving from the database, the known computational parameters based on the software code associated with the similar document; and
using the second prepared MLM to predict the second computational parameters based on the known computational parameters and differences between the received document and similar document.

3. The method of claim 1, wherein determining whether it is safe to execute the software code based on the similarity score further comprises:
when the similarity score is above a first threshold, determining that it is safe to execute the software code and generating a recommendation to execute the software code to a user,
when the similarity score is below a second threshold, determining that it is unsafe to execute the software code and generating a recommendation to not execute the software code to the user, and
when the similarity score is between the first and second thresholds, generating a recommendation review the software code to the user.

4. The method of claim 1, further comprising:
extracting live portions of code from the software code associated with the scientific or technical document and analyzing the extracted live portions of code using the first prepared MLM, wherein the live portion corresponds to segment of code that is actively executing, updating, or responding in real-time within a system.

5. The method of claim 2, wherein using the second prepared MLM to predict the second computation parameters based on the known computational parameters and differences between the received document and the similar document further comprises:
determining a document similarity benchmark based on comparison of the received document and the similar document using the second prepared MLM, wherein the similarity benchmark indicates degree of similarity of the compared documents; and
modifying one or more computational resources of the known computational parameters based on the similarity benchmark to predict corresponding computational resource for the second computational parameters.

6. The method of claim 1, wherein computational resources comprises one or more of: processor utilization, memory utilization, number of computational iterations, or duration of the computation, and/or network utilization.

7. The method of claim 1, further comprising: preparing the first MLM by:
(1) providing, to the first MLM, a code analysis training dataset comprising at least:
(a) a code training dataset comprising at least source code and metadata corresponding to features for the source code to extract patterns that predict computational parameters,
(b) a computational parameter training dataset comprising at least data requirement information and execution configuration information to provide ground truth labels for computational parameters required for execution,
(c) a code-document interaction training dataset comprising at least annotations, mapping rules, and execution example logs to provide additional context about how the software code was executed, and
(d) ground truth labels for the code training dataset, the computational parameter training dataset, and the code-document interaction training dataset to serve as a target output for the first MLM; and
(2) preparing the first MLM using the code analysis training dataset.

8. The method of claim 1, further comprising: preparing the second MLM by:
(1) providing, to the second MLM, a document analysis training dataset comprising at least:
(a) a training documents dataset comprising at least text of training documents and metadata to enable similarity analysis and prediction, wherein the training documents dataset is labeled and annotated to identify a subject matter to group documents,
(b) a code training dataset comprising at least source code associated with the training documents and metadata corresponding to features of source code to capture features from code associated with the training documents to provide execution context,
(c) a computational parameter training dataset comprising at least execution settings and execution logs to provide ground truth labels for computational parameters required for execution,
(d) a similarity training dataset comprising at least document similarity pairs, code similarity pairs, and cross-mapping data to establish relationships between documents based on similarity and associated execution parameters,
(e) ground truth labels for the training documents dataset, the code training dataset, the computational parameter training dataset, and the similarity training dataset to serve as a target output for the second MLM; and
(2) preparing the second MLM using the document analysis training dataset.

9. A system for analyzing safety of software code associated with scientific or technical documents before execution of the software code, comprising:
at least one memory; and
at least one hardware processor coupled with the at least one memory and configured, individually or in combination, to:
receive a scientific or technical document and software code associated with the scientific or technical document, wherein the software code includes executable code and/or source code;
analyze the software code using a first prepared machine learning model (MLM) to predict a first computational parameters based on the software code, wherein the first computational parameters indicates computational resources and/or data sources utilized for execution of the software code;
analyze the scientific or technical document using a second prepared MLM to predict a second computational parameters based on the scientific or technical document and a known computational parameters of a similar scientific or technical document, wherein the second computational parameters indicates computational resources and/or data sources utilized for potential execution of the software code for performing calculations in the scientific or technical document;
compare the first and second computational parameters to generate a similarity score; and
determine whether it is safe to execute the software code based on the similarity score.

10. The system of claim 9, wherein analyzing the scientific or technical document using a second prepared MLM comprises:
using the second prepared MLM to identify, in a database of previously analyzed scientific or technical documents and associated software codes, at least one scientific or technical document substantially similar to the received scientific or technical document;
for the identified similar document, retrieving from the database, the known computational parameters based on the software code associated with the similar document; and
using the second prepared MLM to predict the second computational parameters based on the known computational parameters and differences between the received document and similar document.

11. The system of claim 9, wherein determining whether it is safe to execute the software code based on the similarity score further comprises:
when the similarity score is above a first threshold, determining that it is safe to execute the software code and generating a recommendation to execute the software code to a user;
when the similarity score is below a second threshold, determining that it is unsafe to execute the software code and generating a recommendation to not execute the software code to the user;
when the similarity score is between the first and second thresholds, generating a recommendation review the software code to the user.

12. The system of claim 9, wherein the at least one hardware processor coupled with the at least one memory and configured, individually or in combination, to:
extract live portions of code from the software code associated with the scientific or technical document and analyzing the extracted live portions of code using the first prepared MLM, wherein the live portion corresponds to segment of code that is actively executing, updating, or responding in real-time within a system.

13. The system of claim 10, wherein using the second prepared MLM to predict the second computation parameters based on the known computational parameters and differences between the received document and the similar document further comprises:
determining a document similarity benchmark based on comparison of the received document and the similar document using the second prepared MLM, wherein the similarity benchmark indicates degree of similarity of the compared documents; and
modifying one or more computational resources of the known computational parameters based on the similarity benchmark to predict corresponding computational resource for the second computational parameters.

14. The system of claim 9, wherein computational resources comprises one or more of: processor utilization, memory utilization, number of computational iterations, or duration of the computation, and/or network utilization.

15. The system of claim 9, wherein the at least one hardware processor coupled with the at least one memory and configured, individually or in combination, to: prepare the first MLM by:
(1) providing, to the first MLM, a code analysis training dataset comprising at least:
(a) a code training dataset comprising at least source code and metadata corresponding to features for the source code to extract patterns that predict computational parameters,
(b) a computational parameter training dataset comprising at least data requirement information and execution configuration information to provide ground truth labels for computational parameters required for execution,
(c) a code-document interaction training dataset comprising at least annotations, mapping rules, and execution example logs to provide additional context about how the software code was executed, and
(d) ground truth labels for the code training dataset, the computational parameter training dataset, and the code-document interaction training dataset to serve as a target output for the first MLM; and
(e) ground truth labels for the code training dataset, the computational parameter training dataset, and the code-document interaction dataset to serve as a target output for the first MLM; and
(2) preparing the first MLM using the code analysis training dataset.

16. The system of claim 9, wherein the at least one hardware processor coupled with the at least one memory and configured, individually or in combination, to:
prepare the second MLM by:
(1) providing, to the second MLM, a document analysis training dataset comprising at least:
(a) a training documents dataset comprising at least text of training documents and metadata to enable similarity analysis and prediction, wherein the training documents dataset is labeled and annotated to identify a subject matter to group documents,
(b) a code training dataset comprising at least source code associated with the training documents and metadata corresponding to features of source code to capture features from code associated with the training documents to provide execution context,
(c) a computational parameter training dataset comprising at least execution settings and execution logs to provide ground truth labels for computational parameters required for execution,
(d) a similarity training dataset comprising at least document similarity pairs, code similarity pairs, and cross-mapping data to establish relationships between documents based on similarity and associated execution parameters,
(e) ground truth labels for the training documents dataset, the code training dataset, the computational parameter training dataset, and the similarity training dataset to serve as a target output for the second MLM; and
(2) preparing the second MLM using the document analysis training dataset.

17. A non-transitory computer readable medium storing thereon computer executable instructions for analyzing safety of software code associated with scientific or technical documents before execution of the software code, including instructions for:
receiving a scientific or technical document and software code associated with the scientific or technical document, wherein the software code includes executable code and/or source code;
analyzing the software code using a first prepared machine learning model (MLM) to predict a first computational parameters based on the software code, wherein the first computational parameters indicates computational resources and/or data sources utilized for execution of the software code;
analyzing the scientific or technical document using a second prepared MLM to predict a second computational parameters based on the scientific or technical document and a known computational parameters of a similar scientific or technical document, wherein the second computational parameters indicates computational resources and/or data sources utilized for potential execution of the software code for performing calculations in the scientific or technical document;
comparing the first and second computational parameters to generate a similarity score; and
determining whether it is safe to execute the software code based on the similarity score

18. The non-transitory computer readable medium of claim 17, wherein analyzing the scientific or technical document using a second prepared MLM comprises:
using the second prepared MLM to identify, in a database of previously analyzed scientific or technical documents and associated software codes, at least one scientific or technical document substantially similar to the received scientific or technical document;
for the identified similar document, retrieving from the database, the known computational parameters based on the software code associated with the similar document; and
using the second prepared MLM to predict the second computational parameters based on the known computational parameters and differences between the received document and similar document.

19. The non-transitory computer readable medium of claim 17, wherein determining whether it is safe to execute the software code based on the similarity score further comprises:
when the similarity score is above a first threshold, determining that it is safe to execute the software code and generating a recommendation to execute the software code to a user;
when the similarity score is below a second threshold, determining that it is unsafe to execute the software code and generating a recommendation to not execute the software code to the user;
when the similarity score is between the first and second thresholds, generating a recommendation review the software code to the user.

20. The non-transitory computer readable medium of claim 17, wherein computational resources comprises one or more of: processor utilization, memory utilization, number of computational iterations, or duration of the computation, and/or network utilization.
